(19) United States
(12) Patent Application Publication
(10) Pub. No.: US 2010/0232862 A1
(43) Pub. Date: Sep. 16, 2010

(54) Tape Printing Apparatus and Tape Cassette

(76) Inventor: Kris Vandermeulen, Bornem (BE)

Correspondence Address: MARSHALL, GERSTEIN & BORUN LLP, 233 SOUTH WACKER DRIVE, 6300 WILLIS TOWER, CHICAGO, IL, 60606-6357, US

(21) Appl. No.: 12/375,011

(22) PCT Filed: Jul. 25, 2007
(86) PCT No.: PCT/IB2007/003019

§ 371 Date: Feb. 11, 2009

(30) Foreign Application Priority Data
Jul. 26, 2006 (GB) 0614867.0

(51) Int. Cl. B41J 11/42; B41J 15/04

(52) U.S. Cl. 400/583; 400/613

(57) ABSTRACT

A composite tape supply for use in a tape printer comprising an image receiving layer; a backing layer; and a liner layer.

### FIELD OF THE INVENTION

The present invention relates to a tape printing apparatus, a composite tape supply and to a method of printing on a composite tape to form a label. In particular, the present invention relates to a tape printing apparatus for printing an image, such as a background image, so that the image is printed across the length of the entire label.

### BACKGROUND OF THE INVENTION

Printers capable of printing background images include direct thermal printers.

For example, EP 1638780 describes a method of printing a label in which a multicoloured image is produced on the tape by direct thermal transfer in a single pass of the tape past the print head, resulting in a high quality colour image.

When printing a colour background such as a single block colour, it is possible to print a background which covers the entire width of the label since the width of the print head exceeds the width of the tape. However, printing across the entire length of the label in a single pass is not currently possible due to the location of the cutter in relation to the location of the print head. FIG. 1 (a) shows the relative positions of the print head (60), the platen (80), the cutter (20) and the image receiving tape (44) in a tape printing apparatus during printing. FIG. 1 (b) shows the position of the tape (40) at various stages of printing. As shown in FIGS. 1 (a) and (b) the print line (90) is at a distance x from the cutting line (100). Consequently, after a first label is cut from the tape, a distance x exists between the end of the tape and the printing location. Accordingly the label is printed with a blank leader of length x. Examples of labels printed in this manner are shown in FIG. 2.

Often a blank trailer of the same length is added to the label to give the label a symmetrical appearance. However a blank leader and trailer are usually not desirable, especially when labels are printed with a background therefore making the blank regions noticeable.

The inventors of the present invention have also identified that the image receiving tape may be reversed such that the end of the tape is closer to the print line, therefore decreasing the length of the blank leader. However it is necessary for a portion of tape to be downstream of the print line so that the platen maintains sufficient contact with the tape in order to advance the tape. If there is not a sufficient amount of tape downstream of the print line it is necessary to drive the tape using rollers positioned upstream of the platen.

The inclusion of rollers increases the size of the printer and the complexity of the driving mechanism. Providing drive rollers upstream of the print head can obscure the print station and prevent the tape from entering between the print head and the platen.

Using rollers upstream of the print head to feed the tape between the print head and the platen can cause the tape to distort. This is caused by the force required to feed the tape between the print head and the platen. This force can result in a curl in the tape which makes it difficult to know exactly when the tape has been fed between print head and platen and therefore where the print start position is.

Another disadvantage caused by feeding the tape between the platen and the print head using rollers is that it is difficult to correctly align the tape beneath the print head. when you have a small tape which is moved between a print head and platen. This causes the printed image to be incorrectly positioned on the tape.

A similar problem is evident in printers such as ink jet printers having drive rollers arranged downstream of the print head. When the tape is fed between the drive rollers that are down stream of the print head the tape is likely to distort and to be misaligned.

Embodiments of the present invention aim to address the above-mentioned problems.

### SUMMARY OF THE INVENTION

According to a first aspect of the present invention, there is provided a composite tape supply for use in a tape printer comprising an image receiving layer, a backing layer and a liner layer. The backing layer may be adhered to the image receiving layer. The liner layer may be adhered to the backing layer. The liner layer may be removable from the backing layer to provide a label comprising the image receiving layer and the backing layer. Removal of the backing layer may permit the image receiving layer to be stuck to a surface.

According to a second aspect of the present invention there is provided a cassette for use in a tape printer comprising a body housing a supply of composite tape having a image receiving layer and a liner layer, a supply spool for supplying the composite tape and a take up spool for receiving said liner layer.

According to a third aspect of the present invention there is provided a tape printer comprising a cassette receiving portion for receiving a cassette containing image receiving tape, a print head for printing an image on a tape, a first support for supporting a take up spool in the cassette, a drive means for driving a tape passed the print head in a first direction and a second direction and a control means for controlling the drive means in order to position the tape relative to the print head.

According to a fourth aspect of the present invention there is provided a method of printing on a composite tape supply comprising the steps of printing on an image receiving layer of the tape supply, separating the image receiving layer from a liner layer of the composite tape supply, cutting the printed image receiving layer to form a label and retaining the liner layer in the housing of the printer.

According to a fifth aspect of the present invention there is provided a method of printing an image on an image receiving tape comprising advancing the tape in a first direction such that the end of the image receiving tape is a predetermined distance upstream of the printing location, printing on the tape while advancing the tape in a second direction by means of advancing a liner attached to the image receiving tape and cutting the image receiving tape at a cutting location to form a label.

### BRIEF DESCRIPTION OF DRAWINGS

For a better understanding of the present invention and as to how the same may be carried into effect, embodiments of the present invention will now be described with reference to the following drawings:

FIG. 1(a) shows the relative positions of the print head, cutter and image receiving tape during printing according to the prior art;

FIG. 1(b) shows the image receiving tape at various stages of printing, according to the prior art;

FIG. 2 shows examples of labels produced with blank leaders according to the prior art;

FIG. 3 shows a schematic diagram of a tape printing apparatus according to an embodiment of the present invention;

FIG. 4 shows schematically control circuitry for controlling a tape printing device embodying the present invention;

FIG. 5 shows a schematic cross sectional view of a tape printer according to an embodiment of the present invention;

FIG. 6 shows a schematic cross sectional view of a composite tape according to an embodiment of the present invention;

FIG. 7 shows a schematic cross sectional view of a tape printer according to a further embodiment of the present invention;

FIG. 8 shows a schematic cross sectional view of a tape printer according to a further embodiment of the present invention;

FIG. 9 shows the image receiving tape at various stages of printing, according to a further embodiment of the present invention;

FIG. 10 shows the image receiving tape at various stages of printing, according to a further embodiment of the present invention;

FIG. 11 shows a cross sectional view of a cassette according to the present invention;

FIG. 12 shows a schematic cross sectional view of a tape printer according to a further embodiment of the present invention.

### DETAILED DESCRIPTION

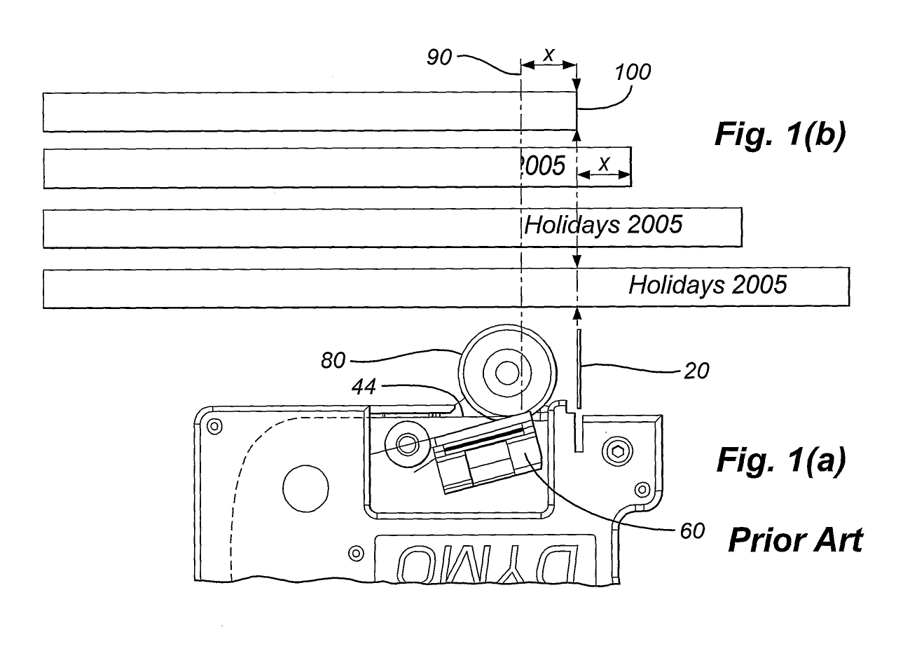

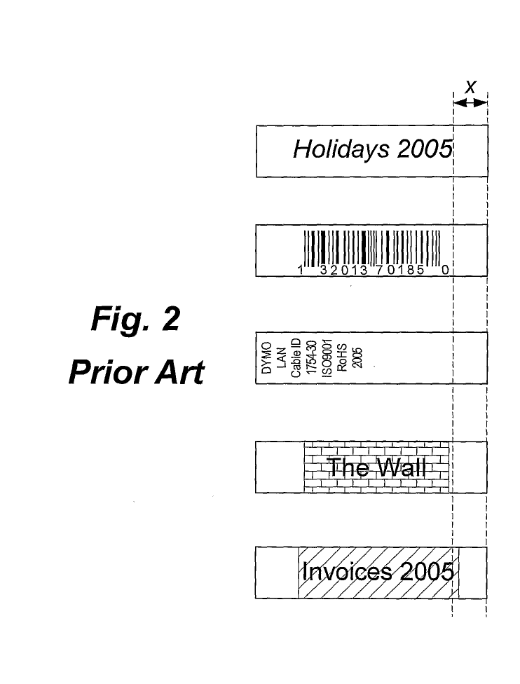

FIGS. 1 and 2 indicate prior art and have already been discussed in the preamble of this specification.

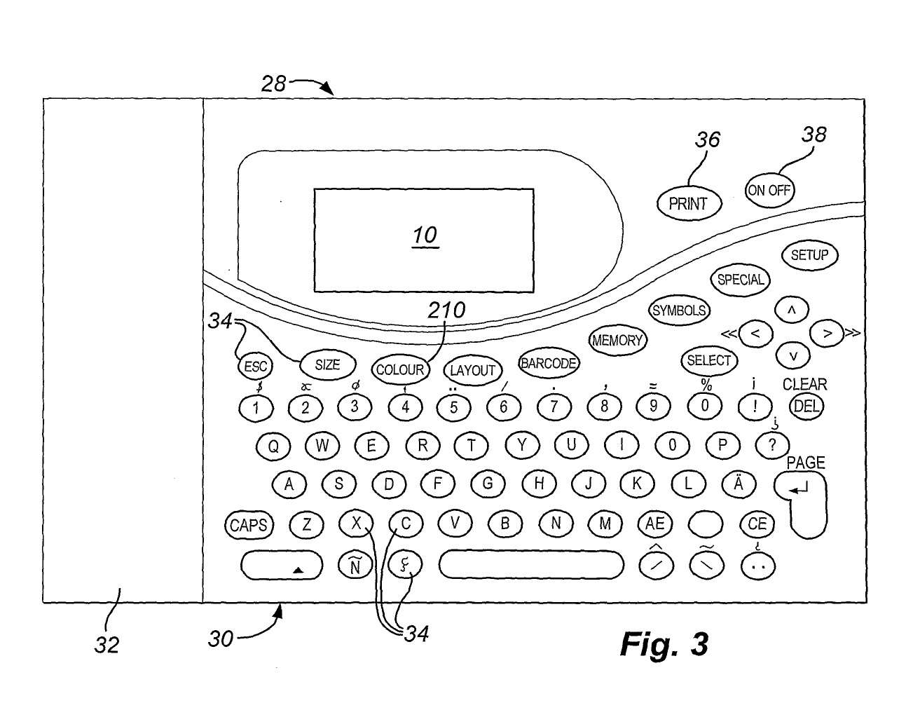

FIG. 3 shows a schematic diagram of a tape printing apparatus 28 according to an embodiment of the present invention. The tape printing apparatus comprises a keyboard 30 and a cassette receiving bay 32. The keyboard has a plurality of data entry keys 34 such as numbered, lettered and punctuation keys for inputting data to be printed as a label and function keys for editing the input data. The keyboard may also have a print key 36 which is operated when it is desired that a label be printed. Additionally an on/off key 38 is also provided for switching the tape printing apparatus on and off.

The tape printing apparatus has a liquid crystal display (LCD) 10 which displays the data as it is entered. The display allows the user to view all or part of the label to be printed which facilitates the editing of the label prior to its printing. Additionally, the display is driven by a display driver (not shown).

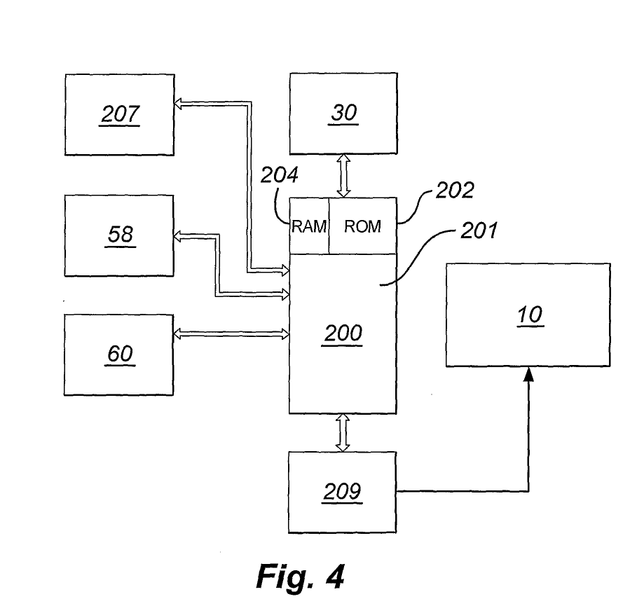

Basic circuitry for controlling the tape printing device 28 is shown in FIG. 4. There is a microprocessor chip 200 having a read only memory (ROM) 202, a microprocessor 201 and random access memory capacity indicated diagrammatically by RAM 204. The microprocessor chip 200 is connected to receive label data input to it from a data input device such as a keyboard 30. The microprocessor chip 200 outputs data to drive a display 10 via a display driver chip 209 to display a label to be printed (or a part thereof) and/or a message for the user. The display driver alternatively may form part of the microprocessor chip. Additionally, the microprocessor chip 200 also outputs data to drive the print head 60 so that the label data is printed onto the image receiving tape to form a label. The microprocessor chip 200 also controls a motor 207 for driving the tape. The manner in which the tape may be driven will be discussed hereinafter. Finally the microprocessor chip 100 also controls the cutting mechanism 58 to allow a length of tape to be cut off.

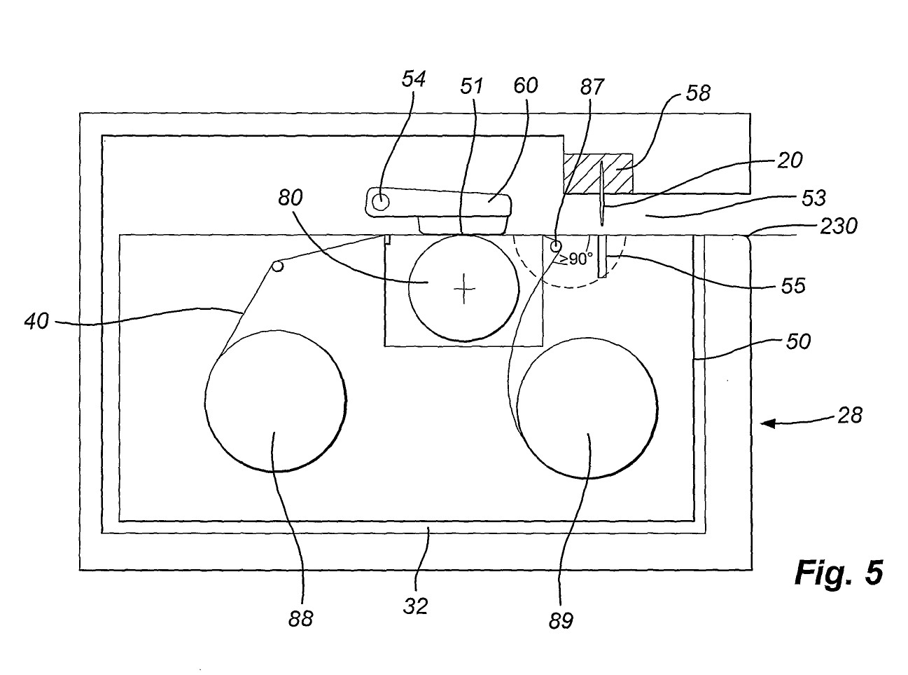

Reference is made to FIG. 5 which shows in plan view a tape printing device 28 according to an embodiment of the present invention which has a cassette 50 arranged therein. This cassette contains a supply of direct thermal material liner tape 40 (described hereinafter) provided on a supply spool 88. The cassette also contains a liner take up spool 89 and spindle 87. The cassette 50 is located in a cassette bay 32. The cassette bay 32 also accommodates at least one thermal print head 60 and a platen 80 which cooperate to define a print zone 51. Other arrangements for the printing are described in more detail hereinafter. The print head 60 is able to pivot about a pivot point 54 so that it can be brought into contact with the platen 80 for printing and moved away from the platen 80 to enable the cassette 50 to be removed and replaced. In the operative position, in one embodiment of the invention the platen 80 is rotated to cause the tape 40 to be driven past the print head 60.

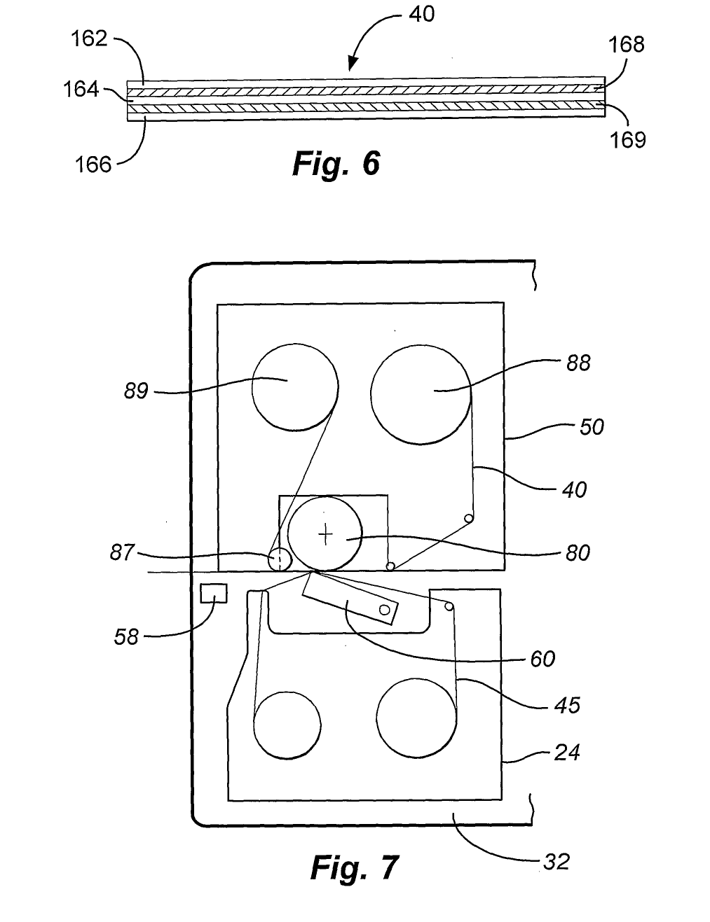

Reference is now made to FIG. 6 which shows a schematic diagram of a liner tape 40 according to an embodiment of the invention. The liner tape comprises an image receiving layer 162 on which an image is printed, an adhesive layer 168 which attaches a releasable backing layer 164, and an adhesive layer 169 which attaches the backing layer to a liner layer 166. According to an embodiment of the invention the material forming the liner layer 166 may be polyethylene or polyester. According to an alternative embodiment of the invention the material forming the liner layer 166 may be paper. The material that may be used for the liner layer is not limited to these examples.

In a preferred embodiment of the invention the backing layer 164 is paper and the liner layer 166 is polyethylene. Since the liner layer is provided on the opposite side of the tape to the image receiving layer 162, the liner layer 166 is the inner layer of the liner tape 40 when the liner tape 40 is wound on the supply spool. Therefore when the liner tape is on the supply spool the liner layer follows a slightly shorter radius than the image receiving layer. It is therefore advantageous for the liner layer to be formed from a material, such as polyethylene, which is flexible to avoid the liner layer from becoming separated from the layers of the tape when the tape is wound on the supply spool.

In a preferred embodiment of the invention the image receiving layer is a direct thermal image receiving layer.

The releasable backing layer is provided in order to cover the adhesive layer 168 of a label which is formed when the tape 40 is cut and ejected from the printer. The user may then peel off the backing layer 164 from the label in order to adhere the label to a surface.

According to one embodiment of the invention the lower surface of the releasable backing layer 164 that contacts the adhesive layer 169 has a lower release value than the upper surface that contacts the adhesive layer 168. This allows the liner layer to be peeled away more easily from the backing layer than the backing layer can be peeled away from the image receiving layer. This may be achieved by providing a different coating on the upper surface and the lower surface of the backing layer 164.

An example showing typical release values on the upper and lower surfaces of the backing layer are given in Table 1. Table 1 shows the test results for a paper backing layer of 63 gsm. The paper has a thickness of 60 μm and is silicone coated on 2 sides with differential release. The test results are provided for two types of adhesive. The test is executed with a 25 mm width tape which is peeled under an angle of 180°.

TABLE 1
TYPICAL RELEASE VALUES_{(TEST CONDITIONS} [symbol] 20187: [symbol] )

| | ADHESIVE | |
|---|---|---|
| | ITAC A7055 | Tesa Tape 7475 |
| | Rubber based adhesive | Acrylic adhesive tape |
| | TEST METHOD | |
| | (STM 1 & 157) | (STM 152 & 157) |
| | RELEASE SPEED | |
| | (g/25 mm) 180° peel at 300 mm/min (low speed) | |
| Side 1 (A12 Release) | 40 | 25 |
| Side 2 (A00 Release) | 10 | 7 |

[symbol]

indicates data missing or illegible when filed

In an alternative embodiment of the invention the tape only includes image receiving layer 162, adhesive layer 168, and liner layer 166. If the adhesive is arranged to remain on the image receiving layer when the image receiving layer and the liner layer have been separated the tape printer will output linerless adhesive labels. If however the adhesive is arranged to remain on the liner when the image receiving layer and the liner layer have been separated the tape printer will output non-adhesive labels.

In a further alternative embodiment of the present invention, the image receiving layer is a thermal transfer tape. This embodiment will be discussed further in relation to FIG. 7 discussed hereinafter.

In a further alternative embodiment of the present invention the image receiving layer may comprise die cut labels arranged on the releasable backing layer 164. According to this embodiment the adhesive layer 168 is only provided in the areas between the die cut labels and the sheets. The die cut labels may be available in different sizes. For example different label sizes may be suited to different applications such as address labels and CD labels.

In operation, the platen 80 is driven by a DC motor (see FIG. 4) so that it rotates to drive the direct thermal material liner tape 40 through the print zone 51 of the tape printing device 28 during printing. In this way, an image is printed on the tape and fed out from the print zone 51. In an alternative embodiment of the invention the motor may be a stepper motor.

According to an embodiment of the invention the liner layer 166 is driven in order to transport the image receiving layer through the printer. In a preferred embodiment of the invention the liner layer is separated from the image receiving layer 162 before the image receiving layer exits the printer and is cut to form a label. The liner layer that has separated from the image receiving layer is stored within the printer so that if the tape is reversed such that the image receiving layer is upstream of the print head there is a portion of the liner tape that remains downstream of the print head in order to transport the image receiving layer past the print head.

The tape may be driven in the forward direction under the rotation of the platen or the take up spool. When driving the tape forward it is necessary to drive the take up spool in order for the liner to be wound onto the take up spool. The take up spool may be driven independently of the platen or driven under the rotation of the platen which may be driven by the motor. In one embodiment of the invention the supply spool may also be rotated in the forward direction to prevent tension in the tape.

The tape may be driven in the reverse direction by rotating the platen in the reverse direction. In one embodiment of the invention the supply spool may be driven in the reverse direction to rewind the tape. In one embodiment of the invention the supply spool is only driven in the reverse direction if tape is to be rewound a large amount compared to the distance between the supply spool and the print head, for example more than 2 cm.

In the preferred implementation, the platen will be driven during reverse feeding and forward feeding.

In an alternative embodiment of the present invention a needled roller assembly may be used to drive the tape in a forward and reverse direction. In this embodiment it is not necessary to drive the platen. The needled roller assembly may be provided outside the cassette.

According to an embodiment of the invention, after the liner tape passes through the print zone the liner layer is drawn back into the cassette onto the liner take up spool 89. The liner layer is drawn over spindle 87 and is advanced in a direction which is at an angle in excess of 90 degrees to the direction of the tape through the print zone as shown in FIG. 5. The angle of 90 degrees is only given as an example. In alternative embodiments of the present invention the angle may be more than or less than 90 degrees, provided that the change in direction of the liner tape is sufficient to separate the liner layer from the rest of the tape. The rigidity of the tape layers cause the backing layer 164 to separate from the liner layer 166 and for the image receiving layer and the backing layer to advance towards the cutter 20 and out of the tape printer at exit 280. Therefore when the tape 40 passes through the cutting location the tape only comprises the image receiving layer 162 and the backing layer 168 attached by adhesive layer 164.

In an alternative embodiment of the invention the spindle 87 may be replaced by a thread extending across the width of the liner layer, a blade like projection or two small pins arranged opposite each other at opposite edges of the liner layer.

In an alternative embodiment of the invention the liner layer may be separated from the rest of the tape by feeding the tape against a member, such as a blade or a thread, such that the rest of the tape is lifted away from the liner layer. According to this embodiment it is not necessary to change the direction of the liner layer in order to separate the liner layer from the rest of the tape. After the liner layer has been separated from the rest of the tape it may be guided towards the take up spool.

In an alternative embodiment of the present invention the tape may be cut before the liner layer is separated from the rest of the tape. In this embodiment the cutter 20 would form a partial, or ‘tab’ cut that extends through the image receiving layer and the backing layer but not the liner layer.

The image is printed by the print head 60 on the tape 40 on a column by column basis with the columns being adjacent one another in the direction of movement of the tape 40. Pixels are selectively activated in each column to construct an image in a manner well known in the art. The DC motor is provided with a shaft encoder for monitoring the speed of rotation of the motor. The control of the speed of the motor is achieved by the microprocessor chip 200 (see FIG. 4) to generate data strobe signals each of which causes a column of pixel data to be printed by the print head 60. The shaft encoder may alternatively be located on the platen, or any other component whose rotation correlates with the position of the tape.

In an alternative embodiment the position of the tape may be detected using a detector that detects markings on the tape. The markings may be provided on the liner layer.

The tape printing device includes at cutting location 53 a cutting mechanism 58 which carries a blade 20. The blade 20 cuts the image receiving tape 40 then enters a slot 55 located in the cassette 50. Alternatively the cutting mechanism may be arranged above a slot provided in the wall of the printer.

It is understood that other embodiments of the tape printer may be envisaged. For example, the tape printer of the present invention may be a PC printer rather than a stand-alone printer. In such a printer, a keyboard and display means are not essential as the data may be input and displayed on the PC. The PC then acts as an input device for the printer. Alternatively, other apparatus may be used to input data to the printer for printing. For example, in an embodiment of the invention a digital camera may be used to input data to the tape printing device for printing. Images may alternatively be input using a smart card, chip card, memory card or the like.

Tape printers embodying the present invention can also be arranged to do thermal transfer printing, that is using an ink ribbon. FIG. 7 shows a schematic diagram of a cassette receiving bay 32 in the tape printing apparatus when arranged to do thermal transfer printing. In this embodiment an ink ribbon cassette 24 is installed together with the image receiving tape cassette 50. The ink ribbon 45 passes through the print zone together with the image receiving tape. According to this embodiment of the invention the image receiving layer 162 is an ink receiving thermal transfer layer.

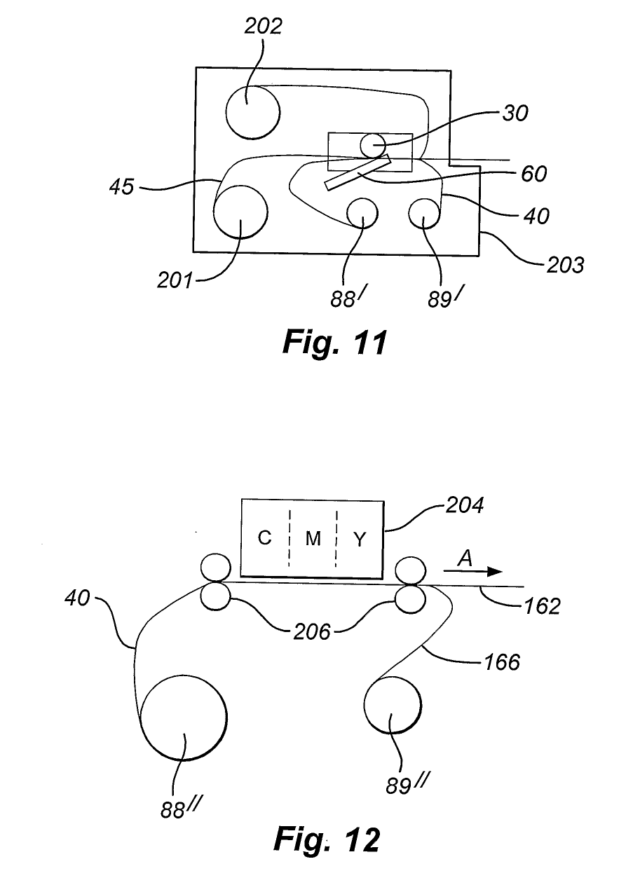

In one modification the ink ribbon is included in the same cassette as the image receiving tape. FIG. 11 shows a diagram of a cassette 203 that includes both the liner tape and an ink ribbon. The ink ribbon 45 is provided on an ink ribbon supply spool 201 and ink ribbon take up spool 202. The cassette 203 also includes liner tape 40 that is provided on a supply spool 88′ and liner layer take up spool 89′.

It should be emphasised that embodiments of the invention are not limited to the examples of the tape materials given in this application. Embodiments of the present invention can be used with full colour direct thermal materials, with direct thermal materials which give a selection of two or more possible colours or materials which may be printed on transferring ink from an ink ribbon.

It should further be emphasised that embodiments of the invention are not limited to the thermal printing technology. Embodiments of the present invention can use inkjet print technology, laser print technology or any other technology to produce an image on an image receiving layer. In one of the embodiments of the present invention the printhead may be an inkjet line print head which prints over the entire width of the tape without a translation movement in the direction perpendicular to the printing direction. FIG. 12 shows an example of an ink jet printer. An ink jet line print head 204 is arranged between a needle roller assembly 206. The needle roller assembly transports the tape 40 beneath the print head in a printing direction A. The liner tape is supplied on supply spool 88″. The liner layer take up spool 89″ takes up the liner layer 166 before the image receiving layer 162, and backing layer if present, exit the printer.

Preferred embodiments of the present invention are arranged so that information is automatically provided to or detected by the tape printer about the capabilities of the material. In other words whether the material is full colour, a thermal transfer material, a direct thermal material only providing one colour or a colour direct thermal material providing two or more colour options and if so what those colour options are. This information can be provided in a number of different ways. For example, the tape supply and/or cassette may have an element which provides the necessary information. In alternative embodiments of the present invention, the user may be able to set this from the keyboard. In other words, the user will provide the tape printer with information as to the type of tape material so that the tape printer can be controlled accordingly.

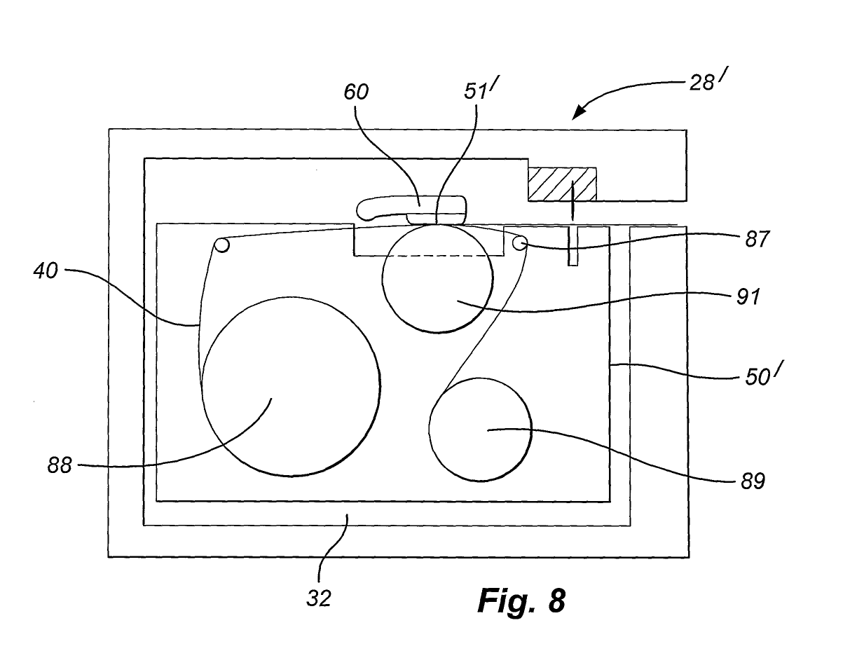

Reference is now made to FIG. 8 which shows a tape printer 28′ and cassette 50′ according to another embodiment of the present invention. In this embodiment, cassette 50′ includes a roller 91 positioned near the opening of the cassette, against the tape 40. The print head 60 in the printer 28′ is arranged such that the roller 91 and the print head correspond to form a print zone 51.′

The inclusion of a roller in the cassette replaces the requirement for a platen in the cassette receiving bay of the printer. This allows the cassette to be loaded in the printer more easily. Cassette 50′ may be side loaded or top loaded into the printer.

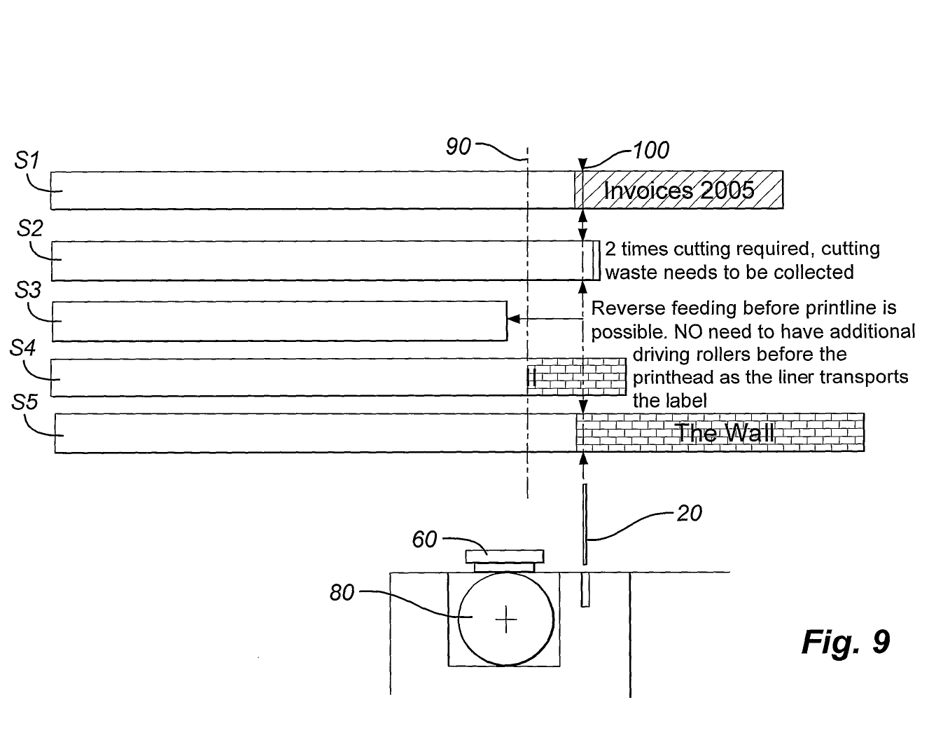

Reference is now made to FIG. 9 which shows the relative positions of the print head 60, the platen 80 and the cutter 20 of a tape printer 28, together with the corresponding positions of the image receiving layer of tape 40 at various steps of printing, according to an embodiment of the present invention. The print line 90 indicates the position where printing occurs. Cutting line 100 indicates the position where a full cut is made.

At step S1 the first label is separated from the remaining tape supply 40 by the cutter 20 performing a full cut at cutting line 100. As shown, the full cut is made at a short distance downstream of the last printed line. Since it is difficult to cut precisely at the last printed line, this ensures that the image on the label extends up to the trailing edge of the label.

At step S2, the tape supply 40 is advanced a small predetermined distance and another full cut is made. This ensures that any printed image remaining from the previous label is removed. Since the section of tape which is cut off is small, it will not reach the tape exit 280 of the tape printer 28. Instead, the section of tape which is cut off is allowed to fall into a waste box (not shown) which is located below the cutting location.

At step S3, the tape is reversed such that the leading edge of the cut image receiving layer 162 is upstream of the print line 90.

At step S4, the tape is advanced towards the print line by driving the liner 166 forward. This may be achieved by driving either the platen 80 or the liner take up spool 154. When the leading edge of the image receiving layer 162 reaches the print line 90, printing is commenced. In another embodiment of the invention printing commences shortly before the image receiving layer reaches the print line in order to ensure that the image is printed at the edge of the tape.

At step S5, when printing is completed the tape is forwarded so that the cutting line 100 is downstream of at least the last printed line. A full cut is then made, separating the label from the tape supply 159.

According to the above embodiment of the present invention, it is possible to produce labels that do not have blank leaders or trailers without the need for separate means for driving the tape when the image receiving tape is upstream of the print head.

In an alternative embodiment of the invention the cutter 20 may be arranged to perform a tab cut at step S2 which cuts through the image receiving layer only. When the liner is drawn over spindle 87, the liner 166 and adhesive 169 are separated from the image receiving layer 162, adhesive 168 and backing layer 166. The portion of the tape between the two tab cuts can for example be used as a transition zone between two entire printed labels. By performing a tab cut at step S2 rather than a full cut the waste portion of the tape is output together with the label. The label can be peeled from the backing layer while the waste portion stays on the backing layer.

In a further alternative embodiment the full cut and the tab cut may be made by two separate blades wherein the blade performing the tab cut is performed upstream of the blade performing the full cut. According to this embodiment it is not necessary to advance the tape at step S2 since the full cut and tab cut can be made simultaneously at step S1.

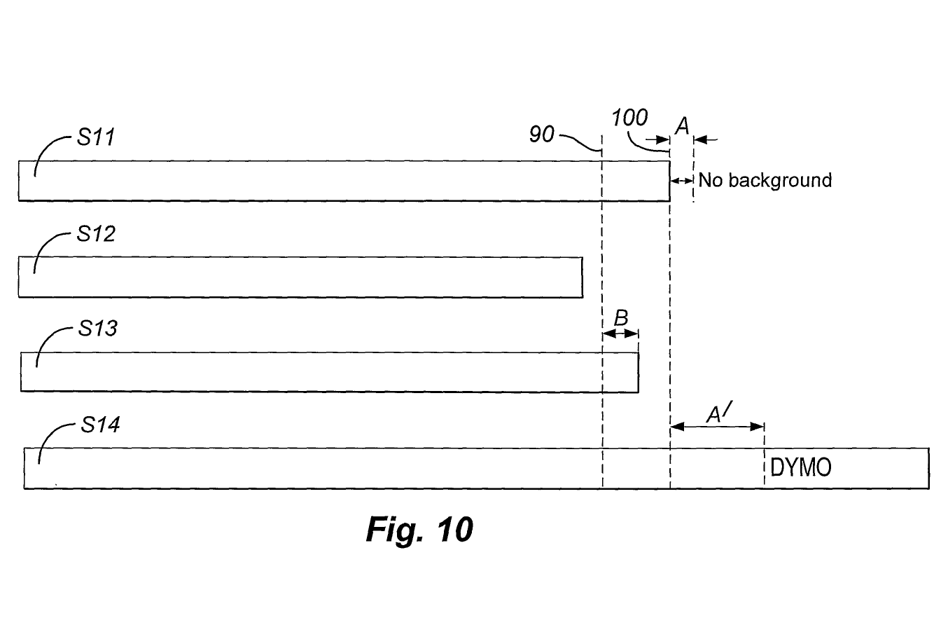

In a further alternative embodiment of the present invention, labels may be printed that do not have a printed background. According to this embodiment it is not necessary to perform two cuts to remove a portion of tape between two consecutive labels. This embodiment is described in relation to FIG. 10.

At step S11 the first label is separated from the remaining tape supply 40 by the cutter 20 performing a full cut at cutting line 100. The full cut is made at distance A upstream of the last printed line. The distance A can be any value starting from zero.

At step S12 the tape is reversed such that the leading edge of the cut image receiving liner tape is upstream of the print line 90.

At step S13 the tape is advanced towards the print line. This may be achieved by driving the platen or the liner take up spool, or both. When the leading edge of the image receiving layer 162 reaches the print line 90, printing can start if required. The printer starts printing when the leading edge is a distance B downstream of the print line. The distance B can be any value starting from zero.

At step S14, when printing is completed the tape is advanced and the label is cut by a full cut at a distance A′ upstream of the last printed line. The distance A′ can be any value starting from zero.

According to the above embodiment of the present invention, it is possible to produce labels that have leaders or trailers starting from zero without the need for separate means for driving the tape when the image receiving tape is upstream of the print head.

In an alternative embodiment, the tape is reversed at step S12 to the position calculated by the controller as the starting position for printing.

It should be appreciated that embodiments of the invention are applicable to continuous tape and also, where appropriate die cut labels arranged on a continuous backing layer.

1-28. (canceled)

29. A cassette for use in a tape printer comprising;
a body housing a supply of composite tape having an image receiving layer, a backing layer, and a liner layer;
a supply for supplying the composite tape; and
a take up spool for receiving said liner layer.

30. A cassette as claimed in claim 29 further comprising a roller for supporting the image receiving tape at a print zone.

31. A cassette as claimed in claim 29 further comprising a member over which the tape is fed in order to change the direction of the path of the liner layer.

32. A tape printer comprising;
a cassette receiving portion for receiving a cassette containing image receiving tape, the image receiving tape having an image receiving layer and a liner layer;
a print head for printing an image on the tape;
a first support for supporting a take up spool for receiving said liner layer;
a driver for driving a tape passed the print head in a first direction and a second direction; and
a controller for controlling the driver in order to position the tape relative to the print head.

33. A tape printer as claimed in claim 32, wherein the first support is for supporting a take up spool for receiving said liner layer in the cassette.

34. A tape printer as claimed in claim 32 wherein the printer further comprises a second support for supporting a supply spool in the cassette.

35. A tape printer as claimed in claim 34 wherein the controller is adapted to control the driver to drive the first support when driving the tape in the first direction and to drive the second support when driving the tape in the second direction in order to position the tape relative to the print head.

36. A tape printer as claimed in claim 32 further comprising a platen which is positioned relative to the print head to form a print zone, wherein the controller is adapted to control the driver to rotate the platen in one direction when driving the tape in the first direction and to rotate the platen in another direction when driving the tape in a second direction.

37. A tape printer a claimed in claim 32 wherein the controller is adapted to control the driver to drive a needle assembly to drive the tape in a first direction and a second direction.

38. A tape printer as claimed in claim 32 wherein the controller is arranged to position the image receiving layer of the tape upstream of the print head when driving the tape in the second direction.

39. A tape printer as claimed in claim 32 wherein the print head is arranged to correspond with a roller in a cassette installed in the cassette receiving portion to form a print zone.

40. A method of printing on a composite tape supply comprising the steps of:
printing on an image receiving layer of the tape supply, the tape supply having the image receiving layer, a backing layer, and a liner layer;
separating the image receiving layer from the liner layer of the composite tape supply;
cutting the printed image receiving layer to form a label; and
retaining the liner layer in the housing of the printer.

41. A method of printing as claimed in claim 40 further comprising the steps of:
driving the tape passed a print head in a first direction and a second direction using a driver; and
controlling the driver using a controller in order to position the tape relative to the print head.

42. A method as claimed in claim 40 wherein the liner layer is driven in order to transport the tape supply.

43. A method of printing on a composite tape supply comprising the steps of:
driving the tape passed a print head in a first direction and a second direction using a driver;
controlling the driver using a controller in order to position the tape relative to the print head;
printing on an image receiving layer of the tape supply;
separating the image receiving layer from a liner layer of the composite tape supply;
cutting the printed image receiving layer to form a label; and
retaining the liner layer in the housing of the printer.

44. A method as claimed in claim 43 wherein the liner layer is driven in order to transport the tape supply.

45. A composite tape supply for use in a tape printer comprising:
an image receiving layer;
a backing layer;
a first adhesive layer between the image receiving layer and the backing layer; a liner layer; and
a second adhesive layer between the backing layer and the liner layer;
wherein a surface of the backing layer that contacts the second adhesive layer has a lower release value than a surface of the backing layer that contacts the first adhesive layer.

46. A composite tape as claimed in claim 45 wherein the image receiving layer is a direct thermal image receiving medium.

47. A composite tape as claimed in claim 45 wherein the image receiving layer is a thermal transfer image receiving medium.

48. A composite tape as claimed in claim 45 wherein the image receiving layer comprises a series of separate labels provided on the backing layer.

49. A composite tape as claimed in claim 45, wherein the first adhesive layer is present only between the separate labels and the backing layer.

50. A cassette for use in a tape printer, the cassette comprising a composite tape supply having:
an image receiving layer;
a backing layer; and
a liner layer.

51. A cassette for use in a tape printer, comprising;
a body housing a supply of composite tape having an image receiving layer and a liner layer;
a supply for supplying the composite tape;
a supply of ink ribbon; and
a take up spool for receiving said liner layer.
